(19) United States
(12) Patent Application Publication
(10) Pub. No.: US 2007/0233768 A1
(43) Pub. Date: Oct. 4, 2007

(54) Method and circuit arrangement for computing a value of a complex signal

(76) Inventors: Robert Fritsch, Berneck (CH); Romed Schur, Waldkirch (DE)

Correspondence Address: O'Shea, Getz & Kosakowski, P.C.;Suite 912, 1500 Main Street, Springfield, MA, 01115, US

(21) Appl. No.: 11/712,202

(22) Filed: Feb. 28, 2007

(30) Foreign Application Priority Data
Feb. 28, 2006 (DE) 10 2006 009 533.2

(51) Int. Cl. G06F 7/38

(52) U.S. Cl. 708/490

(57) ABSTRACT

The invention relates to continuous computing of an averaged value of a complex signal, in which values are produced by iterative processing, such as CORDIC processing, from digital complex input values of in-phase and quadrature components (si, sq) of the complex signal. The smoothed value is provided by processing the input values by two cascading CORDIC processing units with feedback, and a low-pass filtering contained implicitly therein.

### PRIORITY INFORMATION

This patent application claims priority from German patent application 10 2006 009 533.2 filed Feb. 28, 2006, which is hereby incorporated by reference.

### BACKGROUND INFORMATION

The invention relates to continuous computing of a value of a complex signal, and in particular to a system employing CORDIC processing.

In many practical applications one finds complex signals, that is, signals made from pairs of complex valued numbers, and subsequent signal processing requires the accurate values for such a complex signal or a sequence of values of a series of complex signal values. It is generally known how to use an iterative CORDIC processing technique (COordinate Rotation DIgital Computer) to create and furnish values from digital complex input values of two signal components of a complex signal. An advantage of the iterative CORDIC technique is a plurality of shift and addition/subtraction steps are used for the computation, and multiplication steps can be dispensed with. However, such a procedure is relatively expensive. Regardless of the expense, the relatively large number of iteration steps needed to achieve a sufficiently precise value is also a disadvantage. This holds, in particular, for the processing of complex signals when it is necessary to process a plurality of pairs of input values of two signal components in succession.

There is a need for an apparatus and method of continuous computing of a value of a complex signal, wherein the computational expense is reduced.

### SUMMARY OF THE INVENTION

During continuous computing of an averaged value of a complex signal, values or in particular squares of values, are produced by an iterative processing technique such as CORDIC processing, from digital complex input values of two signal components of the complex signal. A smoothed value or square of the value is accomplished by processing the input values by two cascaded CORDIC processing units with feedback.

Advantageously, the CORDICs processing provides filtering.

Averaging or smoothing of the value is preferably performed by low-pass filtering. The low-pass is preferably implicitly contained in the CORDIC nesting.

With each new complex input sampled value, the output provides a value averaged over time, that is, the rate or sampled values according to time of the input values corresponds preferably to the rate of the output values.

The input values may be changed by a sequence for converting Cartesian coordinates into a radius value of polar coordinates. With the two CORDIC processes, one will preferably carry out a limited number of no more than six or slightly more CORDIC iterations. A conversion without any iterations may also be possible for certain suitable input signals or with some kind of preprocessing, especially in the area of the first CORDIC stage.

The input values are preferably mirrored in a first step into a coordinate realm within 45° about the positive real coordinate axis to produce an absolute value of the real component. The mirroring at the beginning, however, is not absolutely necessary. For example, the mirroring can be omitted if a different concatenation structure is chosen for the CORDICs.

The first CORDIC process may determine an approximate value, for example using no more than four iteration steps. In the first CORDIC process, filtering is carried out at the end, preferably a low-pass filtering, by scaling arrangements. In this way, using easily implemented shift and add circuits, for example, multiplications with a fixed coefficient in the manner of a filter coefficient are accomplished.

The second CORDIC process may add the square of the approximate value to the square of an accumulated value to produce a first smoothed value, which is fed back to an input of the second CORDIC process. From this the root is taken, especially in an implicit manner, and thus obtains an updated accumulated value. The second CORDIC process preferably uses no more than three iteration steps. At the end of the second CORDIC process, low-pass filter coefficients may be generated indirectly by a shift and scaling arrangement and low-pass filtering is carried out. The low-pass coefficients may be permanent set points. They are dictated by the gain factor based on the CORDIC iterations, multiplied by the subsequent scaling.

Thus, in a first embodiment, feedback to the input of the second CORDIC stage occurs. The low-pass filtering may occur in conjunction with the second CORDIC stage.

Alternatively, the smoothed approximate value of the second CORDIC process may be fed back to an input of the first CORDIC process. Thus, according to a second embodiment, there is feedback to the input of the first CORDIC stage. In this concatenation structure of the CORDIC processes or CORDIC stages, the low-pass filtering is divided between the two CORDICs.

A circuit arrangement for continuous computing of an averaged value of a complex signal with a CORDIC circuit to provide values, by an iterative CORDIC, from digital complex input values of two signal components of the complex signal, the CORDIC circuit, as a first CORDIC stage, is connected in series to a second CORDIC stage to provide a smoothed value or square of the value by the processing of the input values by cascading first and second CORDIC stages with feedback, in which a low-pass filtering is implicitly contained. With a mirror circuit according to a first embodiment the input values in a first step may be mirrored into a coordinate realm within 45° about the positive real coordinate axis to provide an absolute value of the real component for the first CORDIC stage.

The first CORDIC stage preferably has no more than four iteration steps. The first CORDIC stage preferably includes a scaling and filtering arrangement to perform a low-pass filtering on output values of the first iteration stages and to provide an approximate value.

In the second CORDIC stage, an approximate value from the first CORDIC stage and an accumulated value are summed to provide a first smoothed value as the accumulated value, which is fed back to the second CORDIC stage. The second CORDIC stage preferably uses no more than three iteration stages. In the second CORDIC stage, a final implicit low-pass filter arrangement is preferably implemented to provide the accumulated value as the averaged value.

According to a second embodiment, one output of the second CORDIC stage may be fed back to the first CORDIC stage.

Hence, this makes possible a simple computing of a smoothed value of a complex signal. A block for converting Cartesian coordinates into a smoothed radius value calculates, as the magnitude, a smoothed absolute value of the complex valued input signal making use of two cascading CORDICs or two such consecutively applied CORDIC processes. Such a block implements the measure of the power, especially the measure of the root of the mean signal power. This can be used, for example, for an adaptive gain control (AGC) or a modulation error ratio (MER). Advantageously, no multiplication is required for the block or for the corresponding procedure. Preferably six CORDIC iterations are enough for adequate precision of averaging by the two CORDIC computations.

Since it is especially advantageous to use the block for input signals with peak values no higher than three times the average power, in order to improve the computation especially in the case of signals not falling under this criterion one can accordingly increase a time constant of a smoothing filter. Thus, the absolute value of a complex input signal is ultimately computed with two signal components, wherein smoothing is carried out by a low-pass filter, to obtain the smoothed output signal as a value or a sequence of values.

These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1 illustrates a system for processing a complex signal into a smoothed value;

FIG. 2 illustrates an input stage of the system illustrated in FIG. 1;

FIG. 3 illustrates a first CORDIC stage of the system illustrated in FIG. 1;

FIG. 4 illustrates a second CORDIC stage of the system illustrated in FIG. 1;

FIG. 5 schematically illustrates an implementation of the system of FIG. 1 within an integrated circuit; and

FIG. 6 schematically illustrates a second embodiment of the system for processing a complex signal into a smoothed value.

### DETAILED DESCRIPTION OF THE INVENTION

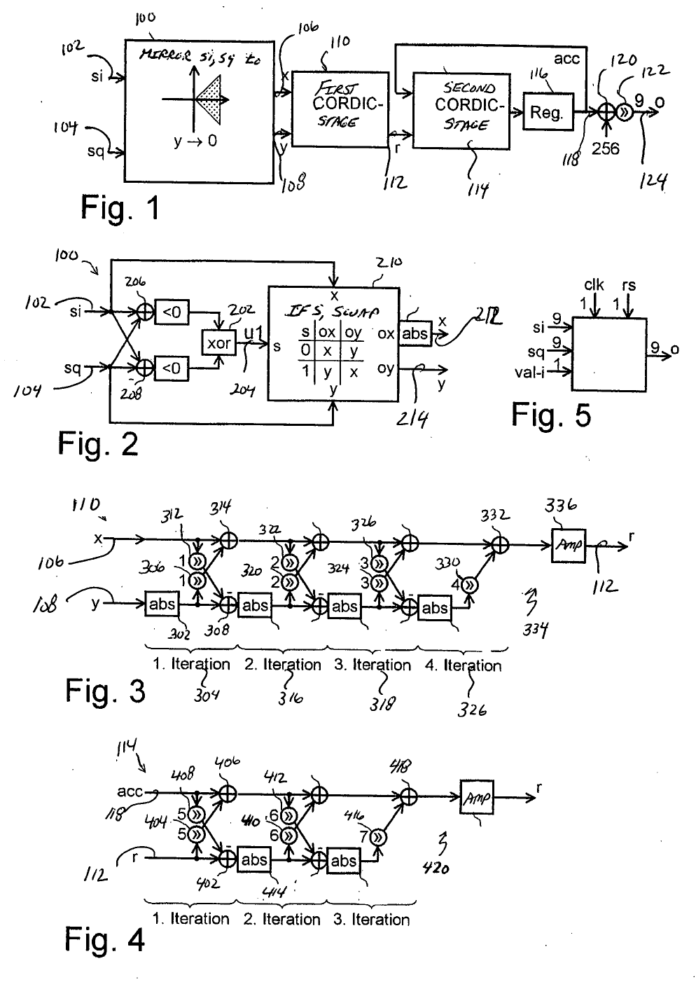

FIG. 1 is a block diagram illustration of a preferred circuit arrangement. A mirror circuit 100 receives in-phase si and quadrature sq signal components on lines 102, 104, respectively, for an input sequence. In a preferred embodiment a multi-component signal is applied each time. The mirror circuit 100 converts the in-phase and quadrature signal components into Cartesian coordinate values x, y provided on lines 106, 108, respectively. In a first step, the input values are mirrored into a coordinate realm of 45° above or below the positive real coordinate axis of the coordinate plane. Thus, the goal is rotation of the phase to zero, that is, of the complex coordinate value y toward or to zero. This is performed in order to obtain a real coordinate value x as the magnitude of the input signal components si, sq. The mirror circuit 100 thus provides a first absolute value of the real component.

The coordinate values x, y output on the lines 106, 108 are applied to a first CORDIC stage 110, which produces from the applied coordinate values x, y a first approximate value r on a line 112 in the manner of a radius value. The first CORDIC stage 110 performs a first low-pass filtering.

The approximate value r on the line 112 is applied to a second CORDIC stage 114, which performs additional CORDIC iterations and implicitly performs a second low-pass filtering. The value or sequence of values produced by the second CORDIC stage 114 is applied to an accumulation register 116. An accumulated value acc on a line 118 is fed back to another input of the second CORDIC stage 114 and used along with the approximate value r on the line 112 for the iteration in the second CORDIC stage 114. Thus, thanks to the second CORDIC stage 114 and the accumulation register 116, a new radius and magnitude are determined and added to the accumulated value on the line 118, which is generally much larger. Furthermore, the accumulated value on the line 118 may be picked off directly at the output of this arrangement and, possibly after an addition in an adder and/or subtracter arrangement 120 and after a shifting in a shift arrangement 122, furnished as the smoothed value on a line 124 to be output. Advantageously, three CORDIC iterations may be enough in the second CORDIC stage 114 to obtain the accumulated value on the line 118 or the smoothed value on the line 124 with a sufficient accuracy.

FIG. 2 illustrates, for example, components of the mirror circuit 100; the components and steps in the figures involving already described aspects will not be described again in the interest of brevity. The mirroring in the mirror circuit 100 includes two additions or one addition and one subtraction and an exclusive-OR circuit 202 regarding the sign bit of the addition results for furnishing a switching signal on a line 204. The switching signal on the line 204 indicates whether or not to swap the first, real component value x or the second, theoretical imaginary component value y. Finally, the absolute value or magnitude of the first, real component value x is obtained.

Referring still to FIG. 2, the in-phase and quadrature signal components on the lines 102, 104, respectively, are presented at the inputs of an adder and/or subtracter arrangement 206 for the addition. Furthermore, the in-phase and quadrature signal components on the lines 102, 104 are presented at an addition input or a subtraction input of another adder and/or subtracter arrangement 208. The sign bit of the two adder and/or subtracter arrangements 206, 208 is presented to the exclusive-OR circuit 202, which provides the switching signal on the line 204.

The switching signal on the line 204 is input to a decision arrangement 210, which also receives the in-phase signal component on the line 102 and the quadrature signal component on the line 104. The decision arrangement 210 outputs two coordinate values x, y on lines 212, 214 respectively, with the first, real coordinate component x of the corresponding value being output via a magnitude output lead 216 for outputting absolute magnitudes. The switching signal on the line 204 controls the outputs of the decision arrangement depending on the state of the signal components on the lines 102, 104. For a switching signal on the line 204 with value 0, the value of the in-phase signal component on the line 102 is presented and output at the first, real output on the line 102, 104 and the value of the quadrature signal component on the line 104 is output on the line 214. Otherwise, the two signal components on the line 102, 104 are presented at the output lines 212, 214 in reverse sequence.

FIG. 3 illustrates an embodiment of the first CORDIC stage 110. At inputs, the two coordinate values x, y or sequences of coordinate values x, y on the lines 106, 108 are presented with every new value or bit. In the first CORDIC stage 110, in this embodiment four CORDIC iterations may be carried out in succession.

At the first CORDIC stage 110 are presented coordinate values x, y, each across an optional shift arrangement. The second coordinate value y on the line 108 is input to a magnitude output unit 302, which constitutes a first element of the first iteration stage 304. The output value of the magnitude output unit 302 is presented at both an additional shift arrangement 306 and an additional adder and/or subtracter arrangement 308. Their output forms, on the part of the second coordinate value y, the end of the first iteration stage. Considered from the other input, the second coordinate values x on the line 106 of the shift arrangement are presented to a further shift arrangement 312 and to an input of an additional adder and/or subtracter arrangement 314. The output of the additional adder and/or subtracter arrangement 314 forms, at this side or line, the output of the first iteration stage 304. From the two shift arrangements 306, 312 of the first iteration stage 304, the single shifted value is presented to the adder and/or subtracter arrangement 314 and 308, respectively. A subtraction occurs in the segment of the second coordinate value y.

The first iteration stage 304 is followed by a second stage 316 and a third iteration stage 318. The shift arrangements 320, 322, 324, 326 of the second and third iteration stage each time perform a single higher shift. In a following fourth iteration stage 326, values located on the branch with the second coordinate value y are taken via an additional magnitude output unit 328 and another fourfold shift arrangement 330 to an adder arrangement 332, at whose other addition input are directly presented output values of the other output of the third iteration stage.

The values produced as the result of the summation constitute input values of a scaling stage 334 for the low-pass filtering. The scaling stage 334 is represented here by an amplifier 336, to which these input values are applied. Output values of the amplifier 336 form the approximate value r on the line 112 and, thus, the output value of the first CORDIC stage 110. Low-pass coefficients may be permanent setpoints here. In particular, they are dictated by the gain due to the CORDIC iterations, multiplied by the subsequent scaling.

Within the CORDIC stages, bits are dropped during each clock cycle. What are retained are the least significant bits (LSB). This is in keeping with the usual circumstances of the CORDIC. The result can only be a vector on the unit circle.

FIG. 4 illustrates the second CORDIC stage 114. The approximate value r on the line 112 is presented at a first input of the second CORDIC stage 114. The accumulated value acc on the line 112 is presented at a second input of the second CORDIC stage 114. The second CORDIC stage 114 includes two iteration stages with a layout as in the case of the first CORDIC stage, with the branch with the approximate value r on the line 112 going directly from the input to an adder and/or subtracter arrangement 402 and being presented at a shift arrangement 404 for a fifth shifting. The accumulated value acc on the line 118 of the other input is presented at another adder and/or subtracter arrangement 406 and another shift arrangement 408. The output of the shift arrangement 404, where the approximate value r on the line 112 is presented is presented at another addition input of the adder and/or subtracter arrangement 406 of the other branch. The output of the other shift arrangement 408 is presented to a subtraction input of the adder and/or subtracter arrangement 402 of the branch with the approximate value r on the line 112. The output values of these two adder and/or subtracter arrangements 402, 406 form output values of the first iteration stage of the second CORDIC stage 114.

These output values of the first iteration stage are presented to a second iteration stage with a layout corresponding to the first iteration stages of the first CORDIC stage 110, and corresponding shift arrangements 410, 412 are provided for a sixth shifting process. The output values of this second iteration stage of the second CORDIC stage 114 are presented to a third iteration stage with a layout corresponding to the fourth iteration stage of the first CORDIC stage 10. The third iteration stage of the second CORDIC stage 114 comprises a magnitude output unit 414, whose output values are presented to a seventh shift arrangement 416, whose output values are presented to a further adder and/or subtracter arrangement 418 for addition to the other output value of the second iteration stage.

Output values of this adder and/or subtracter arrangement 418 are presented to a second scaling stage 420 for the low-pass filtering, which is preferably formed by an amplifier arrangement 422. The accumulator output value acc on the line 118, however, is preferably also presented to the arrangement presented in FIG. 1 including the adder arrangement 120 and the further shift arrangement 122 in order to provide the actual smoothed value o on the line 124 as the output value of the entire arrangement.

FIG. 5 is a block diagram illustration of an integrated circuit with corresponding inputs and outputs for various signals and clock pulses to implement such a circuit arrangement or to carry out a corresponding procedure by an integrated circuit. It shows two inputs for presenting the in-phase and quadrature signal components si, sq. Furthermore, a control signal val-i is presented, which shows whether or not the input signal is valid. Additional inputs include a system clock pulse clk, on which preferably all other signals are based, and the system clock clk serves as the operating clock of the off-band signal portion. Preferably, an input is also provided for presenting a reset signal rs for the circuit arrangement. A corresponding output is provided for outputting the smoothed value o on the line 124. Preferably, the inputs for the signal components si, sq and the output for outputting the smoothed value o serve for presenting preferably multi-valued signals.

The input values as shown in FIG. 1 are mirrored in a first step into a coordinate realm within 45° about the positive real coordinate axis to provide an absolute value of the real component. However, the mirroring at the beginning is not strictly essential; for example the mirroring can be omitted if a different concatenation structure is chosen for the CORDICs.

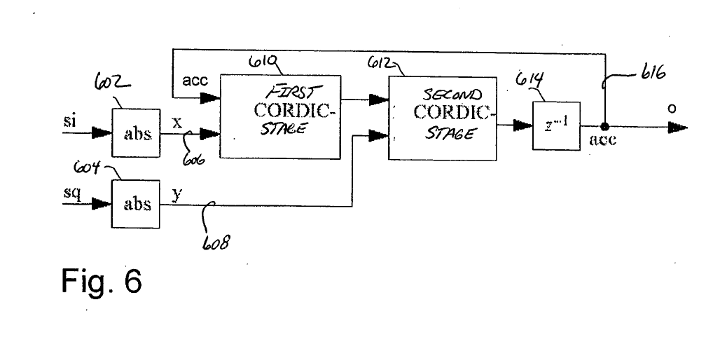

According to a second embodiment illustrated in FIG. 6, there is a feedback to the input of the first CORDIC stage. The in-phase and quadrature inputs are provided to absolute value units 602, 604, respectively, to output two coordinate values x, y on lines 606, 608 respectively as magnitudes at corresponding outputs. The first coordinate value x on the line 606 is presented at the input of a first CORDIC stage 610. The second coordinate value y on the line 608 is presented at the input of a second CORDIC stage 612. The output of the second CORDIC stage 612 is presented to a delay unit 614, which forms the accumulated output value acc on a line 616.

The accumulated output value acc on the line 616 is fed back to the first CORDIC stage 610. The output of the first CORDIC stage 610 is presented to a second input of the second CORDIC stage 612 on a line 618. The smoothed or averaged approximate value of the second CORDIC process is then fed back to an input of the first CORDIC process. With this concatenation structure of the CORDIC processes or CORDIC stages, the low-pass filtering is shared by the two CORDICs. Moreover, a mirroring at the beginning is not needed.

For the smoothing, it can be generally useful to adjust a time constant of the smoothing filter such that peak values of the input signal are no higher than four times, especially no higher than three times, an average power of the input signal.

Although the present invention has been illustrated and described with respect to several preferred embodiments thereof, various changes, omissions and additions to the form and detail thereof, may be made therein, without departing from the spirit and scope of the invention.

What is claimed is:

1. A method for continuous computing of an averaged value of a complex signal, in which values are produced by CORDIC processing from digital complex input values of in-phase (si) and quadrature (sq) components of the complex signal, where a smoothed output value (o) is provided by processing the input values by two cascading CORDIC processors with feedback.

2. The method of claim 1, where the smoothing of the value is done by a low-pass filtering contained implicitly therein.

3. The method of claim 1, where a value averaged over time is produced at the output for each new complex input sampled value.

4. The method of claim 1, where the input values are converted by a sequence for converting of Cartesian coordinates into a radius value of polar coordinates.

5. The method of claim 1, where a limited number of six to nine CORDIC iterations is carried out by the two CORDIC processors.

6. The method of claim 1, where the input values in a first step are mirrored into a coordinate realm within 45° about the positive real coordinate axis (x) to provide an absolute value (x) of the real component.

7. The method of claim 1, where the first CORDIC process determines an approximate value (r), especially by no more than four or five iterations.

8. The method of claim 7, where a scaling arrangement performs a low-pass filtering during the first CORDIC process.

9. The method of claim 7, where the second CORDIC process adds the square of the approximate value (r) to an accumulated square of the value (acc) to provide a first smoothed value (acc), which is fed back to an input of the second CORDIC process.

10. The method of claim 7, where the smoothed approximate value of the second CORDIC process is fed back to an input of the first CORDIC process.

11. The method of claim 9, where a low-pass filtering is carried out by a scaling arrangement (120) during the second CORDIC process.

12. A circuit arrangement for continuous computing of an averaged value of a complex signal, comprising a CORDIC circuit to provide values by CORDIC processing, from digital complex input values of in-phase and quadrature signal components (si, sq) of the complex signal, where the CORDIC circuit includes a first CORDIC stage (110) connected in series to a second CORDIC stage (114) to provide a smoothed output value (o) by processing the input values in the cascaded the first and second CORDIC stages (110, 114) with feedback, in which a low-pass filter is implicitly contained.

13. The circuit arrangement of claim 12, with an arrangement for providing a value averaged over time at the output with each new complex input sampled value.

14. The circuit of claim 12, with a mirror circuit (100) for mirroring the input values in a first step into a coordinate realm within 45° about the positive real coordinate axis (x) in order to provide an absolute value of the real component for the first CORDIC stage (110).

15. The circuit arrangement of claim 12, in which the first CORDIC stage (110) has iteration stages.

16. The circuit arrangement of claim 12, in which the first CORDIC stage (110) has a scaling arrangement (334) to implicitly carry out a low-pass filtering on output values of the first computing stage and to furnish an approximate value (r).

17. The circuit arrangement of claim 12, in which the second CORDIC stage (114) adds up an approximate value (r) of the first CORDIC stage (110) presented at an input and an accumulated value (acc) in order to provide a first smoothed value as the accumulated value (acc), which is fed back to another input of the second CORDIC stage (114).

18. The circuit arrangement of claim 12, in which one output of the second CORDIC stage (114) is fed back to an input of the first CORDIC stage (110).

19. The circuit arrangement of claim 17, where a final, implicitly included low-pass filter arrangement is implemented in the first and/or the second CORDIC stage (110, 114) to furnish the accumulated value (acc) as the averaged value.
